(19) United States
(12) Patent Application Publication
(10) Pub. No.: US 2017/0306201 A1
(43) Pub. Date: Oct. 26, 2017

(54) ADHESIVE COMPOSITIONS AND USES THEREOF

(71) Applicants: Dow Corning Corporation, Midland, MI (US); Dow Corning Toray Co., Ltd., Tokyo (JP)

(72) Inventors: Masaaki Amako, Chiba (JP); Michelle Cummings, Midland, MI (US); Steven Swier, Midland, MI (US)

(21) Appl. No.: 15/513,251

(22) PCT Filed: Sep. 23, 2015
(86) PCT No.: PCT/US2015/051677

§ 371 Date: Mar. 22, 2017

Related U.S. Application Data
(60) Provisional application No. 62/054,080, filed on Sep. 23, 2014.

(51) Int. Cl. C09J 183/10; C08G 77/04; C09J 7/00; C09J 5/06; C08G 77/44; C08G 77/00

(52) U.S. Cl. CPC C09J 183/10; C09J 5/06; C08G 77/44; C08G 77/04; C09J 7/00; C08G 77/80; C09J 2203/326; C09J 2483/00

(57) ABSTRACT

Adhesive compositions are disclosed. In some embodiments, the adhesive compositions comprise an organosiloxane block copolymer, wherein the blocks of the block copolymer consist of an —Si—O—Si— backbone. The organosiloxane block copolymer comprises at least two blocks that are phase-separated. The organosiloxane block copolymer has at least a first glass transition temperature (Tg¹) and a second glass transition temperature (Tg²), the second glass transition temperature being at 25° C. or higher. A 1 mm thick cast film of the adhesive composition has, in some embodiments, a light transmittance of at least 95%. The adhesive composition of the various embodiments of the present invention can be B-staged at about Tg² or at about 100° C. below Tg².

### CLAIM OF PRIORITY

This application claims the benefit of priority to U.S. Provisional Patent Application Ser. No. 62/054,080, filed Sep. 23, 2014, the disclosure of which is incorporated herein in its entirety by reference.

### BACKGROUND

Many electronic devices use adhesives (e.g., die attach adhesives) to bond two or more components and/or substrates of the electronic device. Many of the currently available adhesives, however, are not durable (e.g., after prolonged use in electronic devices that operate at elevated temperatures, such as light emitting diodes); do not maintain optical clarity after prolonged use, especially at elevated temperatures (e.g., polycarbonates); are not able to effectively bond certain substrates; do not provide bond line thickness control; and/or are not easy to apply. There is therefore a continuing need to identify adhesives in many areas of emerging technologies that do not suffer from the aforementioned deficiencies.

### DETAILED DESCRIPTION OF THE EMBODIMENTS

The various embodiments of the present invention provide compositions that can be B-staged, thus allowing great flexibility in the manufacture of, among other articles, electronic devices. As used herein, the term “B-staged” (and its variants, including “B-staging”) is used to refer to the processing of a material by heat or irradiation so that the material is partially cured. This is different from the “A-stage,” where the material is uncured, and the “C-stage,” where the material is fully cured. B-staging can provide low flow without fully curing, such that additional curing may be performed after the adhesive is used to bond or join one article to another (e.g., an electronic device and a substrate to which the electronic device is bonded or joined). As a result, compositions of the various embodiments of the present invention not only provide protection to circuitry, but also provide acceptable levels of bonding when the compositions are used as adhesives. Further, when used as adhesives, such compositions offer bond line thickness control.

The compositions of the embodiments described herein comprise organosiloxane block copolymer(s). In some embodiments, the compositions can be used as adhesives to bond two or more substrates. The substrates bonded can be any suitable substrates including, but not limited to, metal (e.g., aluminum and gold), silicon, glass, polyphthalamide (PPA), ceramic, thermoplastics, and combinations thereof.

In some embodiments, the backbones of the blocks of the block copolymer consist of —Si—O—Si— linkages where at least two blocks are phase-separated. In other words, the backbones in the blocks of the block copolymer do not contain, e.g., organic-siloxane blocks or organic-organic blocks, such as, but not limited to, polyurea blocks, polyimide blocks, polycarbonate blocks, polyurethane blocks, polyacrylate blocks, polyisobutylene blocks, and the like. Specifically excluded block copolymers are polyurea-polydimethylsiloxanes; polycarbonate-polydimethylsiloxanes; and polyimide-polydimethylsiloxanes.

An example of organosiloxane block copolymers contained in the compositions of the embodiments described herein includes organosiloxane block copolymers comprising units of the formula [R¹₂SiO_{2/2}], units of the formula [R²SiO_{3/2}], and [SiOH] groups. In some embodiments, the units [R¹₂SiO_{2/2}] are arranged in linear blocks, the units [R²SiO_{3/2}] are arranged in non-linear blocks having a molecular weight of at least 500 g/mole, and at least 30 mole % of the non-linear blocks are crosslinked with each other, each linear block linked to at least one non-linear block.

Examples of organosiloxane block copolymer(s), wherein the organosiloxane block copolymer consist of an —Si—O—Si— backbone include organosiloxane block copolymers comprising: 50 to 85 mole percent units of the formula [R¹₂SiO_{2/2}], 15 to 50 mole percent units of the formula [R²SiO_{3/2}], 2 to 30 mole percent [SiOH] groups; wherein: each R¹, at each occurrence, is independently a C₁ to C₃₀ hydrocarbyl, each R², at each occurrence, is independently a C₁ to C₂₀ hydrocarbyl, wherein: the units [R¹₂SiO_{2/2}] are arranged in linear blocks having an average of from 40 to 250 units [R¹₂SiO_{2/2}] per linear block, the units [R²SiO_{3/2}] are arranged in non-linear blocks having a molecular weight of at least 500 g/mole, and at least 30% of the non-linear blocks are crosslinked with each other, each linear block linked to at least one non-linear block, and the organosiloxane block copolymer has an average molecular weight (M_{w}) of at least 20,000 g/mole.

At each occurrence, each R¹ in the [R¹₂SiO_{2/2}] unit is independently a C₁ to C₃₀ hydrocarbyl, where the hydrocarbyl group may independently be an alkyl, aryl, or alkylaryl group. Each R¹, at each occurrence, may independently be a C₁ to C₃₀ alkyl group, alternatively, at each occurrence, each R¹ may be a C₁ to C₁₈ alkyl group. Alternatively each R¹, at each occurrence, may be a C₁ to C₆ alkyl group such as methyl, ethyl, propyl, butyl, pentyl, or hexyl. Alternatively each R¹, at each occurrence, may be methyl. Each R¹, at each occurrence, may be an aryl group, such as phenyl, naphthyl, or an anthryl group. Alternatively, each R¹, at each occurrence, may be any combination of the aforementioned alkyl or aryl groups such that, in some embodiments, each disiloxy unit may have two alkyl groups (e.g., two methyl groups); two aryl groups (e.g., two phenyl groups); or an alkyl (e.g., methyl) and an aryl group (e.g., phenyl). Alternatively, each R¹, at each occurrence, is phenyl or methyl.

Each R², at each occurrence, in the [R²SiO_{3/2}] unit is independently a C₁ to C₂₀ hydrocarbyl, where the hydrocarbyl group may independently be an alkyl, aryl, or alkylaryl group. Each R², at each occurrence, may be a C₁ to C₂₀ alkyl group, alternatively each R², at each occurrence, may be a C₁ to C₁₈ alkyl group. Alternatively each R², at each occurrence, may be a C₁ to C₆ alkyl group such as methyl, ethyl, propyl, butyl, pentyl, or hexyl. Alternatively each R², at each occurrence, may be methyl. Each R², at each occurrence, may be an aryl group, such as phenyl, naphthyl, or an anthryl group.

In some embodiments, each R² at each occurrence is phenyl. In other embodiments, each R¹, at each occurrence, is independently methyl or phenyl. In still other embodiments, each R² at each occurrence is phenyl and each R¹, at each occurrence, is independently methyl or phenyl. In yet other embodiments, R¹ is selected such that the disiloxy units have the formula [(CH₃)(C₆H₅)SiO_{2/2}]. In still other embodiments, R¹ is selected such that the disiloxy units have the formula [(CH₃)₂SiO_{2/2}].

As used throughout the specification, hydrocarbyl also includes substituted hydrocarbyls. “Substituted” as used throughout the specification refers broadly to replacement of one or more of the hydrogen atoms of the group with substituents known to those skilled in the art and resulting in a stable compound as described herein. Examples of suitable substituents include, but are not limited to, amine (e.g., primary and secondary amine and dialkylamino), hydroxy, cyano, carboxy, nitro, sulfur containing groups (e.g., thiol, sulfide, disulfide), alkoxy (e.g., C₁-C₃₀ alkoxy), and halogen groups.

Methods of preparing such resin-linear organosiloxane block copolymers and compositions comprising such block copolymers are known in the art. See, e.g., Published PCT Application Nos. WO2012/040305 and WO2012/040367, the entireties of both of which are incorporated by reference as if fully set forth herein.

The units [R¹₂SiO_{2/2}] are primarily bonded together to form polymeric chains having, in some embodiments, an average of from 40 to 250 [R¹₂SiO_{2/2}] units (e.g., an average of from about 40 to about 200; about 45 to about 200; about 50 to about 200; about 50 to about 150, about 70 to about 200; about 70 to about 150; about 100 to about 150, about 115 to about 125, about 90 to about 170 or about 110 to about 140 [R¹₂SiO_{2/2}] units), which are referred herein as “linear blocks.” In some embodiments, when the “linear” units are [PhMeSiO_{2/2}], the units are primarily bonded together to form polymeric chains having an average of from about 70 to about 150 units. In other embodiments, when the “linear” units are [Me₂SiO_{2/2}], the units are primarily bonded together to form polymeric chains having an average of from about 45 to about 200 units.

The [R²SiO_{3/2}] units are, in some embodiments, primarily bonded to each other to form branched polymeric chains, which are referred to as “non-linear blocks.” In some embodiments, a significant number of these non-linear blocks may further aggregate to form “nano-domains” when solid forms of the block copolymer are provided. In some embodiments, these nano-domains form a phase separate from a phase formed from linear blocks having [R¹₂SiO_{2/2}] units, such that a resin-rich phase forms.

In some embodiments, the organosiloxane block copolymers contain from about 30 wt. % to about 50 wt. % or from about 35 wt. % to about 45 wt. % [PhSiO_{3/2}] units. In other embodiments, the organosiloxane block copolymers contain [Me₂SiO_{2/2}] units and [PhSiO_{3/2}] units, wherein the [Me₂SiO_{2/2}] units are primarily bonded together to form polymeric chains having an average of from about 45 to about 200 units and the organosiloxane block copolymers contain from about 20 wt. % to about 50 wt. % or from about 35 wt. % to about 45 wt. % [PhSiO_{3/2}] units.

In some embodiments, the non-linear blocks have a number average molecular weight of at least 500 g/mole, e.g., at least 1000 g/mole, at least 2000 g/mole, at least 3000 g/mole or at least 4000 g/mole; or have a molecular weight of from about 500 g/mole to about 4000 g/mole, from about 500 g/mole to about 3000 g/mole, from about 500 g/mole to about 2000 g/mole, from about 500 g/mole to about 1000 g/mole, from about 1000 g/mole to 2000 g/mole, from about 1000 g/mole to about 1500 g/mole, from about 1000 g/mole to about 1200 g/mole, from about 1000 g/mole to 3000 g/mole, from about 1000 g/mole to about 2500 g/mole, from about 1000 g/mole to about 4000 g/mole, from about 2000 g/mole to about 3000 g/mole or from about 2000 g/mole to about 4000 g/mole.

In some embodiments, at least 30 mole % of the non-linear blocks are crosslinked with each other, e.g., at least 40 mole % of the non-linear blocks are crosslinked with each other; at least 50 mole % of the non-linear blocks are crosslinked with each other; at least 60 mole % of the non-linear blocks are crosslinked with each other; at least 70 mole % of the non-linear blocks are crosslinked with each other; or at least 80 mole %. In other embodiments, from about 30 mole % to about 80 mole % of the non-linear blocks are crosslinked with each other; from about 30 mole % to about 70 mole % of the non-linear blocks are crosslinked with each other; from about 30 mole % to about 60 mole % of the non-linear blocks are crosslinked with each other; from about 30 mole % to about 50 mole % of the non-linear blocks are crosslinked with each other; from about 30 mole % to about 40 mole % of the non-linear blocks are crosslinked with each other; from about 40 mole % to about 80 mole % of the non-linear blocks are crosslinked with each other; from about 40 mole % to about 70 mole % of the non-linear blocks are crosslinked with each other; from about 40 mole % to about 60 mole % of the non-linear blocks are crosslinked with each other; from about 40 mole % to about 50 mole % of the non-linear blocks are crosslinked with each other; from about 50 mole % to about 80 mole % of the non-linear blocks are crosslinked with each other; from about 50 mole % to about 70 mole % of the non-linear blocks are crosslinked with each other; from about 55 mole % to about 70 mole % of the non-linear blocks are crosslinked with each other, from about 50 mole % to about 60 mole % of the non-linear blocks are crosslinked with each other; from about 60 mole % to about 80 mole % of the non-linear blocks are crosslinked with each other; or from about 60 mole % to about 70 mole % of the non-linear blocks are crosslinked with each other.

The crosslinking of the non-linear blocks may be accomplished via a variety of chemical mechanisms and/or moieties. For example, crosslinking of non-linear blocks within the block copolymer may result from the condensation of residual silanol groups present in the non-linear blocks of the copolymer. Crosslinking of the non-linear blocks within the block copolymer may also occur between “free resin” components and the non-linear blocks. “Free resin” components may be present in the block copolymer compositions as a result of using an excess amount of an organosiloxane resin during the preparation of the block copolymer. The free resin component may crosslink with the non-linear blocks by condensation of the residual silanol groups present on the non-blocks and on the free resin. The free resin may provide crosslinking by reacting with lower molecular weight compounds added as crosslinkers, as described herein. The free resin, when present, may be present in an amount of from about 10% to about 20% by weight of the organosiloxane block copolymers of the embodiments described herein, e.g., from about 15% to about 20% by weight organosiloxane block copolymers of the embodiments described herein.

Alternatively, certain compounds may be added during the preparation of the block copolymer to specifically crosslink the non-resin blocks. These crosslinking compounds may include an organosilane having the formula R⁵_{q}SiX_{4-q}, which is added during the formation of the block copolymer, where R⁵ is a C₁ to C₈ hydrocarbyl or a C₁ to C₈ halogen-substituted hydrocarbyl; X is a hydrolyzable group; and q is 0, 1, or 2. R⁵ is a C₁ to C₈ hydrocarbyl or a C₁ to C₈ halogen-substituted hydrocarbyl, or alternatively R⁵ is a C₁ to C₈ alkyl group, or alternatively a phenyl group, or alternatively R⁵ is methyl, ethyl, or a combination of methyl and ethyl. X is any hydrolyzable group, alternatively X may be an oximo, acetoxy, halogen atom, hydroxyl (OH), or an alkoxy group.

In one embodiment, the organosilane having the formula R⁵_{q}SiX_{4-q} is an alkyltriacetoxysilane, such as methyltriacetoxysilane, ethyltriacetoxysilane, or a combination of both. Commercially available representative alkyltriacetoxysilanes include ETS-900 (Dow Corning Corp., Midland, Mich.).

Other suitable, non-limiting organosilanes useful as crosslinkers include; methyl tris(methylethylketoxime)silane (MTO), methyl triacetoxysilane, ethyl triacetoxysilane, tetraacetoxysilane, tetraoximesilane, dimethyl diacetoxysilane, dimethyl dioximesilane, and methyl tris(methylmethylketoxime)silane.

In some embodiments, the crosslinks within the block copolymer will primarily (or entirely) be siloxane bonds, —Si—O—Si—, resulting from the condensation of silanol groups, as discussed herein.

The amount of crosslinking in the block copolymer may be estimated by determining the average molecular weight of the block copolymer, such as with GPC techniques. In some embodiments, crosslinking the block copolymer increases its average molecular weight. Thus, an estimation of the extent of crosslinking may be made, given the average molecular weight of the block copolymer, the selection of the linear siloxy component (that is the chain length as indicated by its degree of polymerization), and the molecular weight of the non-linear block (which is primarily controlled by the selection of the selection of the organosiloxane resin used to prepare the block copolymer).

In some embodiments, organosiloxane block copolymers of the embodiments described herein comprise 50 to 85 mole percent units of the formula [R¹₂SiO_{2/2}], e.g., 50 to 70 mole percent units of the formula [R¹₂SiO_{2/2}]; 55 to 65 mole percent units of the formula [R¹₂SiO_{2/2}]; 50 to 60 mole percent units of the formula [R¹₂SiO_{2/2}]; 60 to 80 mole percent units of the formula [R¹₂SiO_{2/2}]; or 55 to 85 mole percent units of the formula [R¹₂SiO_{2/2}]; 50 to 75 mole percent units of the formula [R¹₂SiO_{2/2}]; or 65 to 75 mole percent units of the formula [R¹₂SiO_{2/2}].

In some embodiments, the organosiloxane block copolymers of the embodiments described herein comprise 15 to 50 mole percent units of the formula [R²SiO_{3/2}], e.g., 30 to 50 mole percent units of the formula [R²SiO_{3/2}]; 35 to 45 mole percent units of the formula [R²SiO_{3/2}]; 20 to 50 mole percent units of the formula [R²SiO_{3/2}]; 15 to 40 mole percent units of the formula [R²SiO_{3/2}]; 20 to 30 mole percent units of the formula [R²SiO_{3/2}]; or 25 to 50 mole percent units of the formula [R²SiO_{3/2}].

It should be understood that organosiloxane block copolymers of the embodiments described herein may contain additional siloxy units, such as [R¹₃SiO_{1/2}] units and [SiO_{4/2}] units, such that the sum of the mole % amounts of each component unit adds up to 100 mole %.

The SiOH groups may be present on any siloxy units within the organosiloxane block copolymer. The amount described herein represent the total amount of SiOH groups found in the organosiloxane block copolymer. In some embodiments, the majority (e.g., greater than 75%, greater than 80%, greater than 90%; from about 75% to about 90%, from about 80% to about 90%, or from about 75% to about 85%) of the SiOH groups will reside on the [R²SiO_{3/2}] units, i.e., the resin component of the block copolymer. Although not wishing to be bound by any theory, the silanol groups present on the resin component of the organosiloxane block copolymer allows for the block copolymer to further react or cure at elevated temperatures.

In some embodiments, the organosiloxane block copolymers of the embodiments described herein have a weight average molecular weight (M_{w}) of at least 20,000 g/mole, alternatively a weight average molecular weight of at least 40,000 g/mole, alternatively a weight average molecular weight of at least 50,000 g/mole, alternatively a weight average molecular weight of at least 60,000 g/mole, alternatively a weight average molecular weight of at least 70,000 g/mole, or alternatively a weight average molecular weight of at least 80,000 g/mole. In some embodiments, the organosiloxane block copolymers of the embodiments described herein have a weight average molecular weight (M_{w}) of from about 20,000 g/mole to about 250,000 g/mole or from about 100,000 g/mole to about 250,000 g/mole, alternatively a weight average molecular weight of from about 40,000 g/mole to about 100,000 g/mole, alternatively a weight average molecular weight of from about 50,000 g/mole to about 100,000 g/mole, alternatively a weight average molecular weight of from about 50,000 g/mole to about 80,000 g/mole, alternatively a weight average molecular weight of from about 50,000 g/mole to about 70,000 g/mole, alternatively a weight average molecular weight of from about 50,000 g/mole to about 60,000 g/mole. In some embodiments, the organosiloxane block copolymers of the embodiments described herein have a number average molecular weight (Mₙ) of from about 15,000 to about 50,000 g/mole; from about 15,000 to about 30,000 g/mole; from about 20,000 to about 30,000 g/mole; or from about 20,000 to about 25,000 g/mole. The average molecular weight may be readily determined using Gel Permeation Chromatography (GPC) techniques, such as those described in the Examples.

The present disclosure further provides curable compositions comprising, in some instances, an organic solvent. In some embodiments, the organic solvent is an aromatic solvent, such as benzene, toluene or xylene.

In one embodiment, the curable compositions may further contain an organosiloxane resin (e.g., free resin that is not part of the block copolymer). The organosiloxane resin present in these compositions is, in some embodiments, the same organosiloxane resin used to prepare the organosiloxane block copolymer. Thus, the organosiloxane resin may comprise 50 to 85 mole percent disiloxy units of the formula [R¹₂SiO_{2/2}], e.g., 50 to 70 mole percent disiloxy units of the formula [R¹₂SiO_{2/2}]; 55 to 65 mole percent disiloxy units of the formula [R¹₂SiO_{2/2}]; 50 to 60 mole percent disiloxy units of the formula [R¹₂SiO_{2/2}]; 60 to 80 mole percent disiloxy units of the formula [R¹₂SiO_{2/2}]; or 55 to 85 mole percent disiloxy units of the formula [R¹₂SiO_{2/2}]; 50 to 75 mole percent disiloxy units of the formula [R¹₂SiO_{2/2}]; or 65 to 75 mole percent disiloxy units of the formula [R¹₂SiO_{2/2}], wherein each R², at each occurrence, is independently a C₁ to C₂₀ hydrocarbyl. Alternatively, the organosiloxane resin is a silsesquioxane resin, or alternatively a phenyl silsesquioxane resin.

Curable compositions can contain condensation catalysts including metal ligand complexes or organic bases. The condensation catalysts are added to enhance the cure (e.g., the cure rate) of the compositions containing the resin-linear organosiloxane copolymers.

The metal ligand complex may be selected from any metal ligand complexes known for catalyzing condensation reactions, such as metal ligand complexes based on Al, Bi, Sn, Ti, and/or Zr. Alternatively, the metal ligand complex comprises an aluminum-containing metal ligand complex.

Alternatively, the metal ligand complex comprises any tetravalent tin-containing metal ligand complex capable of promoting and/or enhancing the cure of the compositions containing the resin-linear organosiloxane copolymers described herein. In some embodiments, the tetravalent tin-containing metal ligand complex is a dialkyltin dicarboxylate. In some embodiments, the tetravalent tin-containing metal ligand complex includes those comprising one or more carboxylate ligands including, but not limited to, dibutyltin dilaurate, dimethyltin dineodecanoate, dibutyltin diacetate, dimethylhydroxy(oleate)tin, dioctyldilauryltin, and the like.

The ligand associated with the metal may be selected from various organic groups, including those known for the ability to form ligand complexes with the metal selected as the condensation catalyst. In some embodiments, the ligand is selected from carboxylate ligands, β-diketonate ligands, and/or α-diketonate ligands.

In one embodiment, the ligand is acetylacetonate, also known as an “acac” ligand. In one embodiment, the metal ligand complex selected as the catalyst is aluminum acetylacetonate.

The amount of metal ligand complex added to the present compositions may vary, depending on the selection of the metal ligand complex and the resin-linear organosiloxane block copolymer. In some embodiments, the amount of metal ligand complex added may be the amount sufficient to catalyze a condensation reaction to, e.g., cure a composition. In other embodiments, the amounts of metal ligand complex added may be from 1 to 1000 ppm of the metal (e.g., from about 1 to about 1000 ppm; from about 1 to about 500 ppm; from about 1 to about 250 ppm; from about 1 to about 125 ppm; from about 1 to about 50 ppm; from about 50 to about 1000 ppm; from about 125 to about 1000 ppm; from about 250 to about 1000 ppm; from about 500 to about 1000 ppm; from about 50 to about 500 ppm; from about 125 to about 500 ppm; from about 250 to about 500; from about 50 to about 250 ppm; from about 125 to about 250; or from about 50 to about 125 ppm) per the amount of resin-linear organosiloxane copolymer (e.g., “solids” of the copolymer) in, e.g., curable compositions.

Examples of organic bases include, but are not limited to:
1,8-Diazabicyclo[5.4.0]undec-7-ene (DBU), (CAS #6674-22-2)
1,5,7-Triazabicyclo[4.4.0]dec-5-ene (TBD), (CAS #5807-14-7)
1,4-Diazabicyclo[2.2.2]octane (DABCO), (CAS #280-57-9)
1,1,3,3-Tetramethylguanidine (TMG), (CAS #80-70-6)
1,5-Diazabicyclo[4.3.0]-5-nonene (DBN), (CAS #3001-72-7)
7-Methyl-1,5,7-triazabicyclo[4.4.0]dec-5-ene (MTBD) (CAS #84030-20-6)
   or combinations thereof.

The structures for each of these are shown below:

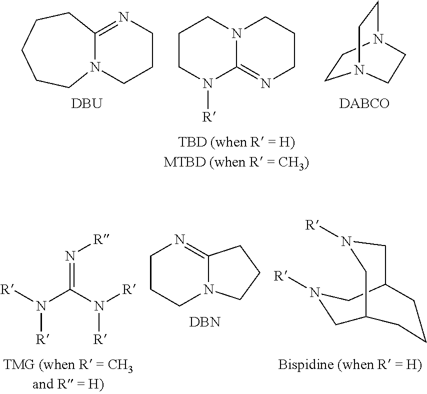

where each R′ is the same or different and is hydrogen or C₁-C₅ alkyl; and R″ is hydrogen or C₁-C₅ alkyl. As used herein, the term “C₁-C₅ alkyl” refers broadly to a straight or branched chain saturated hydrocarbon radical. Examples of alkyl groups include, but are not limited to, straight chained alkyl groups including methyl, ethyl, n-propyl, n-butyl; and branched alkyl groups including isopropyl, tert-butyl, iso-amyl, neopentyl, and the like. In some embodiments, the hydrocarbon radical is methyl.

The amount of the organic base present in a curable composition may vary and is not limiting. In some embodiments, the amount added is a catalytically effective amount, which may vary depending on the organic base selected, as well as the concentration of residual silanol groups in the linear-resin copolymer composition, especially the amount of residual silanol groups on the resin components, and particularly the silanol amount on the “free resin” components in the composition. The amount of organic base catalyst is typically measured in parts per million (ppm) in the curable composition. In particular, the catalyst level is calculated in regard to copolymer solids. The amount of organic base catalyst added to the curable compositions may range from 0.1 to 1,000 ppm, alternatively from 1 to 500 ppm, or alternatively from 10 to 100 ppm, as based on the resin-linear block copolymer content (by weight) present in the curable compositions. For convenience for measuring and adding to the present compositions, the organic base may be diluted in an organic solvent before adding to the curable compositions. In some embodiments, the organic base in diluted in the same organic solvent as used in the curable compositions.

Solid compositions containing organosiloxane block copolymers of the various embodiments of the present invention can be prepared by removing the solvent from the curable organosiloxane block copolymer compositions as described herein (e.g., during a B-staging process). The solvent may be removed by any known processing techniques. In one embodiment, a film of the curable compositions containing the organosiloxane block copolymers is formed, and the solvent is allowed to evaporate from the film. Subjecting the films to elevated temperatures, and/or reduced pressures, will accelerate solvent removal and subsequent formation of the solid curable composition. Alternatively, the curable compositions may be passed through an extruder to remove solvent and provide the solid composition in the form of a ribbon or pellets. Coating operations against a release film could also be used as in slot die coating, knife over roll, rod, or gravure coating. Also, roll-to-roll coating operations could be used to prepare a solid film. In coating operations, a conveyer oven or other means of heating and evacuating the solution can be used to drive off the solvent and obtain the final solid film.

In some embodiments, the aforementioned organosiloxane block copolymers are isolated in a solid form, for example by casting films of a solution of the block copolymer in an organic solvent (e.g., benzene, toluene, xylene or combinations thereof) and allowing the solvent to evaporate at ambient temperature, at elevated temperature (e.g., at 40-80° C. for a period of from about an hour to about two days or more at ambient pressure, such as 1 atm, or in vacuo). Under these conditions, the aforementioned organosiloxane block copolymers can be provided as solutions in an organic solvent containing from about 50 wt % to about 80 wt % solids, e.g., from about 60 wt % to about 80 wt %, from about 70 wt % to about 80 wt % or from about 75 wt % to about 80 wt % solids. In some embodiments, the solvent is toluene. In some embodiments, such solutions will have a viscosity of from about 1500 cSt to about 4000 cSt at 25° C., e.g., from about 1500 cSt to about 3000 cSt, from about 2000 cSt to about 4000 cSt or from about 2000 cSt to about 3000 cSt at 25° C.

Upon drying or forming a solid, non-linear blocks of the block copolymer further aggregate together to form “nano-domains.” As used herein, “predominately aggregated” means the majority of the non-linear blocks of the organosiloxane block copolymer are found in certain regions of the solid composition, described herein as “nano-domains.” As used herein, “nano-domains”refers to those phase regions within the solid block copolymer compositions that are phase separated within the solid block copolymer compositions and possess at least one dimension sized from 1 to 100 nanometers. The nano-domains may vary in shape, providing at least one dimension of the nano-domain is sized from about 1 to about 500 nm, about 10 to about 500 nm, about 10 to about 200 nm or about 10 to about 100 nm, wherein the size of the domain relates to the smallest dimension, such that, e.g., a lamellar phase can be micron size in one direction, but nanometer size across. Thus, the nano-domains may be regular or irregularly shaped. The nano-domains may be spherically shaped, tubular shaped, and in some instances lamellar shaped.

In a further embodiment, the solid organosiloxane block copolymers as described herein contain a first phase and an incompatible second phase, the first phase containing predominately [R¹₂SiO_{2/2}] units as defined herein, the second phase containing predominately [R²SiO_{3/2}] units as defined herein, the non-linear blocks being sufficiently aggregated into nano-domains which are incompatible with the first phase.

When solid compositions are formed from the curable compositions of the organosiloxane block copolymer, which can also contain an organosiloxane resin, as described herein, the organosiloxane resin also predominately aggregates within the nano-domains.

The structural ordering of the disiloxy and trisiloxy units in the solid block copolymers of the present disclosure, and characterization of the nano-domains, may be determined explicitly using certain analytical techniques such as Transmission Electron Microscopic (TEM) techniques, Atomic Force Microscopy (AFM), Small Angle Neutron Scattering, Small Angle X-Ray Scattering, and Scanning Electron Microscopy.

Alternatively, the structural ordering of the [R¹₂SiO_{2/2}] and [R²SiO_{3/2}] units in the block copolymer, and formation of nano-domains, may be implied by characterizing certain physical properties of coatings resulting from the present organosiloxane block copolymers. For example, the present organosiloxane copolymers may provide coatings or films that have an optical transmittance of light having a wavelength from about 350 nanometers (nm) to about 1000 nm of at least 95%, e.g., at least 96%; at least 97%; at least 98%; at least 99%; or 100% transmittance of visible light, even when the coatings or films reach a thickness of from about 50 μm to about 500 μm or greater (e.g., 1 mm). One skilled in the art recognizes that such optical clarity is possible (other than refractive index matching of the two phases) when visible light is able to pass through such a medium and not be diffracted by particles (or domains as used herein) having a size greater than 150 nanometers. As the particle size, or domains further decreases, the optical clarity may be further improved.

One advantage of the organopolysiloxanes block copolymers of the various embodiments of the present invention is that they can be processed several times, because the processing temperature (T_{processing}) is less than the temperature required to finally cure (T_{cure}) the organosiloxane block copolymer, i.e., T_{processing}<T_{cure}. However the organosiloxane copolymer will cure and achieve high temperature stability when T_{processing} is taken above T_{cure}. Thus, the present resin-linear organopolysiloxanes block copolymers offer a significant advantage of being “re-processable” in conjunction with the benefits that may be associated with silicones, such as; hydrophobicity, high temperature stability, moisture/UV resistance.

In some embodiments, solid compositions containing organosiloxane block copolymers of the various embodiments of the present invention have at least a first glass transition temperature (T_{g}¹) and a second glass transition temperature (T_{g}²), the second glass transition temperature being at 25° C. or higher. In other embodiments, solid compositions of the embodiments described herein can be B-staged at about T_{g}² or at about 100° C. below T_{g}² (e.g., at about 75° C. below or at about 50° C. below T_{g}²; from about 50° C. to about 100° C. below T_{g}²). For example, T_{g}² is at about 25° C. or higher, 50° C. or higher; about 80° C. or higher; or about 100° C. or higher. In some embodiments, T_{g}² is from about 25° C. to about 350° C., about 60° C. to about 80° C., from about 50° C. to about 100° C., from about 50° C. to about 80° C., from about 70° C. to about 100° C., from about 50° C. to about 300° C., from about 50° C. to about 200° C., from about 50° C. to about 150° C., from about 100° C. to about 200° C., from about 50° C. to about 250° C. or from about 100° C. to about 300° C. And solid compositions of the embodiments described herein can be B-staged at about T_{g}² or at about 50° C. below T_{g}².

In some embodiments, solid compositions containing organosiloxane block copolymers of the various embodiments of the present invention have a T_{g}² at or near the operating temperature of an electronic device (e.g., an electronics package or an LED, where such electronic devices often go through temperature cycles from about −30° C. to about 200° C.). In some embodiments, compositions of the embodiments described herein cure at a temperature above T_{g}². For example, compositions of the embodiments described herein cure at a temperature of from about 60° C. to about 400° C., from about 60° C. to about 250° C., from about 100° C. to about 250° C., from about 100° C. to about 300° C. or from about 150° C. to about 300° C.

In some embodiments, solid compositions containing organosiloxane block copolymers of the various embodiments of the present invention have a T_{g}¹ that is less than about 40° C., less than about 25° C., less than about 0° C., less than about −10° C., less than about −50° C. or less than about −100° C. In some embodiments, the T_{g}¹ is from about −25° C. to about 40° C., from about −15° C. to about 40° C., from about −5° C. to about 40° C., from about −25° C. to about 0° C., from about 0° C. to about 25° C., from about 10° C. to about 40° C. or from about 0° C. to about 40° C. In other embodiments, the T_{g}¹ is from about −130° C. to about 40° C., from about −100° C. to about 40° C., from about −50° C. to about 40° C., from about −25° C. to about 40° C., from about 0° C. to about 25° C., from about 10° C. to about 40° C. or from about 0° C. to about 40° C.

In some embodiments, solid compositions containing organosiloxane block copolymers of the various embodiments of the present invention have a maximum tan δ of from about 0.5 to about 2.5 (e.g., from about 0.6 to about 1.5, about 1.0 to about 2.5, about 1.5 to about 2.5 or about 0.5 to about 2.0) at a temperature of from about 100° C. to about 200° C. (e.g., from about 100° C. to about 150° C., about 100° C. to about 180° C., about 110° C. to about 150° C., about 110° C. to about 175° C. or about 125° C. to about 180° C.). In some embodiments, solid compositions containing organosiloxane block copolymers of the various embodiments of the present invention have a maximum tan δ at the aforementioned temperatures even after B-staging at about 80° C. for about 24 hours or after heating at about 40° C. for about 10 days. In some embodiments, solvent borne samples can be prepared by drawing down a film of material, drying at 70° C. for 30 minutes, followed by B-staging. Once B-staged the material can be folded upon itself and consolidated with slight pressure (e.g., <1 torr) at elevated temperatures (e.g., at 120° C.) for a suitable amount of time (e.g., for a few seconds, such as about 60 seconds or less). Such a sample can be analyzed on an Ares parallel plate rheometer to determine, among other parameters, the maximum tan δ, G′ value, G″, and the G′/G″ crossover as determined by ramping at 5° C./min from 30° to 300° C.

In some embodiments, solid compositions containing organosiloxane block copolymers of the various embodiments of the present invention have a minimum G′ value of from about 0.5 to about 350 kPa (e.g., from about 0.5 to about 1 kPa, about 1 to about 10 kPa, about 5 kPa to about 50 kPa, about 50 kPa to about 350 kPa, about 100 to about 350 kPa or about 1 to about 2 kPa) at a temperature from about 100° C. to about 200° C. (e.g., from about 110° C. to about 175° C., about 110° C. to about 130° C. or about 115° C. to about 175° C.). In some embodiments, solid compositions containing organosiloxane block copolymers of the various embodiments of the present invention have a minimum G′ value at the aforementioned temperatures even after B-staging at about 80° C. for about 24 hours or after heating at about 40° C. for about 10 days.

In some embodiments, solid compositions containing organosiloxane block copolymers of the various embodiments of the present invention have a G′/G″ crossover (gel point) at a temperature of from about 120° C. to about 200° C. (e.g., from about 130° C. to about 195° C., about 150° C. to about 200° C. or about 160° C. to about 195° C.). In some embodiments, solid compositions containing organosiloxane block copolymers of the various embodiments of the present invention have a gel point at the aforementioned temperatures even after B-staging at about 80° C. for about 24 hours or after heating at about 40° C. for about 10 days.

In some embodiments, solid compositions containing organosiloxane block copolymers of the various embodiments of the present invention are adhesive compositions that can be used to bond or join one article to another. In some embodiments, the strength of the bond between the bonded or joined articles, as represented by the 90° peel strength in pounds per inch (ppi) is at least about 4 ppi (e.g., about 4 ppi to about 8 ppi, about 6 ppi to about 8 ppi or about 4 ppi to about 7 ppi) before heating at, e.g., 40° C. for 10 days or after heating at, e.g., 40° C. for 10 days and/or at 80° C. for 24 hours. In other words the strength of the bond between the bonded or joined articles, as represented by the 90° peel strength in pounds per inch (ppi), is at least 4 ppi before or after B-staging at 80° C. for 24 hours. The strength of the bond between the bonded or joined articles can be tested per ASTM D 429 Method B.

In some embodiments, solid compositions containing organosiloxane block copolymers of the various embodiments of the present invention can further comprise siloxane additives including, but not limited to, silanol terminated siloxanes of the formula HO—[R¹₂SiO]ₓH, wherein each R¹ is the same or different and is defined herein and the subscript x is an integer of from 2 to 100 (e.g., from 2 to 10, from 2 to 6, from 2 to 4, from 10 to 50, from 10 to 100 or from 50 to 100). In some embodiments silanol terminated 2-100 dp siloxanes have the formula HO-[PhMeSiO]ₓH.

In some embodiments, solid compositions containing organosiloxane block copolymers of the various embodiments of the present invention can further comprise siloxane additives including, but not limited to, cyclic organopolysiloxanes include, but are not limited to cyclic organopolysiloxanes of the following formulae P3 and P4:

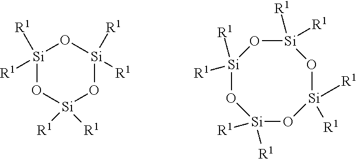

wherein each R¹ is the same or different and is defined herein (e.g., R¹ can be PhMe or Me₂).

In some embodiments, solid compositions containing organosiloxane block copolymers of the various embodiments of the present invention can further comprise adhesion promoters (e.g., glycidoxypropylmethyldimethoxysilane, glycidoxypropylmethyldiethoxysilane glycidoxypropyltrimethoxysilane, 1-methoxy-3,7-bis[{3-(trimethoxysilyl)propoxy}methyl]-9-carbasilatrane, Dow Corning® APZ-3, and combinations thereof).

The solid compositions containing organosiloxane block copolymers of the various embodiments of the present invention can further comprise a filler, as an optional component. The filler may comprise a reinforcing filler, an extending filler, a conductive filler, or a combination thereof. The exact amount of the filler present may depend on various factors including the form of the reaction product of the composition and whether any other fillers are added. In some embodiments, the amount of filler may depend on a target hardness or modulus for, e.g., a solid compositions described herein, such that higher target hardness and/or modulus may require higher filler loadings. Non-limiting examples of suitable reinforcing fillers include carbon black, zinc oxide, magnesium carbonate, aluminum silicate, sodium aluminosilicate, and magnesium silicate, as well as reinforcing silica fillers such as fume silica, silica aerogel, silica xerogel, and precipitated silica. Fumed silicas are known in the art and commercially available; e.g., fumed silica sold under the name CAB-O-SIL by Cabot Corporation of Massachusetts, U.S.A.

The term “about,” as used herein, can allow for a degree of variability in a value or range, for example, within 10%, within 5%, or within 1% of a stated value or of a stated limit of a range.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range.

Embodiments of the invention described and claimed herein are not to be limited in scope by the specific embodiments herein disclosed, since these embodiments are intended as illustration of several aspects of the disclosure. Any equivalent embodiments are intended to be within the scope of this disclosure. Indeed, various modifications of the embodiments in addition to those shown and described herein will become apparent to those skilled in the art from the foregoing description. Such modifications are also intended to fall within the scope of the appended claims.

The Abstract is provided to allow the reader to quickly ascertain the nature of the technical disclosure. It is submitted with the understanding that it will not be used to interpret or limit the scope or meaning of the claims.

### EXAMPLES

The following examples are included to demonstrate specific embodiments of the invention. However, those of skill in the art should, in light of the present disclosure, appreciate that many changes can be made in the specific embodiments which are disclosed and still obtain a like or similar result without departing from the spirit and scope of the invention.

### Example 1: Preparation of (PhMeSiO_{2/2})_{0.52}(PhSiO_{3/2})_{0.42} (45 wt % Phenyl-T)

A 500 mL 4-neck round bottom flask was loaded with Dow Corning 217 Flake (45.0 g, 0.329 moles Si) and toluene (Fisher Scientific, 70.38 g). The flask was equipped with a thermometer, Teflon stir paddle, and a Dean Stark apparatus attached to a water-cooled condenser. A nitrogen blanket was applied; the Dean Stark apparatus was prefilled with toluene; and an oil bath was used for heating. The reaction mixture was heated at reflux for 30 minutes. After cooling the reaction mixture to 108° C., a solution of diacetoxy terminated PhMe siloxane was added quickly. The diacetoxy terminated PhMe siloxane was prepared by adding a 50/50 wt MTA/ETA (methyltriacetoxysilane/ethyltriacetoxysilane) (1.21 g, 0.00523 moles Si) mixture to a solution of 140 dp silanol terminated PhMe siloxane (55.0 g, 0.404 moles Si) dissolved in toluene (29.62 g). The solution was mixed for 2 hours at room temperature under a nitrogen atmosphere. After the diacetoxy terminated PhMe siloxane was added, the reaction mixture was heated at reflux for 2 hours. At this stage 50/50 wt MTA/ETA (7.99 g, 0.0346 moles Si) was added at 108° C. The reaction mixture was heated at reflux for an additional 1 hour. The reaction mixture was cooled to 90° C. and then deionized (DI) water (12 mL) was added. The temperature was increased to reflux and the water was removed by azeotropic distillation. The reaction mixture was cooled again to 90° C. and more DI water (12 mL) was added. The reaction mixture was once again heated up to reflux and the water was removed. Some toluene (56.9 g) was then removed by distillation to increase the solids content. The material was cooled to room temperature and then pressure filtered through a 5.0 μm filter.

The was subsequently loaded with different condensation cure catalysts:

50 ppm DBU was loaded (vs. total solids)
75 ppm Al from Al(acac)3 was loaded (vs. total solids)

### Example 2

A 3 L 4 neck round bottom flask was loaded with Dow Corning 217 Flake (378.0 g, 2.77 moles Si) and toluene (Fisher Scientific, 1011.3 g). The flask was equipped with a thermometer, Teflon stir paddle, and a Dean Stark apparatus attached to a water-cooled condenser. A nitrogen blanket was applied, Dean Stark was prefilled with toluene, and an oil bath was used for heating. The mixture was heated at reflux for 30 minutes. A bottle was loaded with silanol terminated PDMS (462.0 g siloxane, 6.21 mols Si) and toluene (248.75 g). It was capped with 50/50 methyl triacetoxysilane/ethyl triacetoxysilane (MTA/ETA) (31.12 g, 0.137 mols Si) in a glove box (same day) under nitrogen by adding the 50/50 MTA/ETA to the PDMS and mixing at room temperature for 1 h. The capped PDMS was added to the 217 flake solution quickly and heated to reflux for 2 hrs. The solution was cooled to 108° C. and 28.4 g of MTA/ETA 5/5 ratio was added, followed by reflux for 1 h. The solution was cooled to 90° C. and 89.3 g of DI water was added. Temperature was increased to reflux and the water was removed by azeotropic distillation. Toluene was distilled off (884.6 g) to increase the solids content to about 70%.

### Comparative Example 1

The components set forth below are mixed using a planetary mixer, Flack-tec, for 30 seconds at 3500 rpm to form a solution.

Component 1: Average Unit Molecular Formula: (Me₂ViSiO_{1/2})_{0.25}(PhSiO_{3/2})_{0.75}; 5.8 g.

Component 2: Average Unit Molecular Formula: Me₂ViSiO(MePhSiO)₂₅OSiMe₂Vi; 1.8 g.

Component 3: Average Unit Molecular Formula: HMe₂SiO(Ph₂SiO)SiMe₂H; 2.0 g.

Component 4: Average Unit Molecular Formula: (HMe₂SiO_{1/2})_{0.60}(PhSiO_{3/2})_{0.4}; 0.24 g.

Component 5: Average Unit Molecular Formula: (Me₂ViSiO_{1/2})_{0.18}(PhSiO_{3/2})_{0.54}(EpMeSiO)_{0.28} wherein (Ep=gricidoxypropyl); 0.23 g.

Component 6: Average Unit Molecular Formula: Cyclic (ViSiMeO_{1/2})ₙ; 0.02 g.

ETCH; 240 ppm, Pt Catalyst (1.3-divinyltetramethylsiloxane complex); 2 ppm.

### Example 3: Adhesion Testing

Fiberglass cloth strips 1 inch in width, 6 inches in length were cut and placed onto a fluorinated ethylene propylene (FEP) release liner. The adhesive composition of the various embodiments of the present invention was drawn down over top the fiberglass strips to impregnate them with the adhesive composition. Adhesive compositions comprising solvent were dried in an oven at 70° C. for 30 minutes to remove the solvent. After the solvent removal, the impregnated strips were placed onto a 4 inch×4 inch very high temperature nonporous high alumina ceramic, supplied from McMaster-Carr Supply Company and the adhesive composition was B-staged at 80° C. for 24 hours.

Samples comprising the composition of Comparative Example 1 were placed directly into a hot press, with a set point temperature of 150° C. for 1 hour. Samples comprising the composition of Examples 1 and 2 were placed in a laminator at 145° C. under vacuum for 90 seconds. Pressure using a bladder at 15 psi was applied for 10 seconds, then the pressure was released and vacuum was released. All samples were then placed in an oven at 150° C. for 4 hours to cure. Samples were then tested per ASTM D6862 Standard Method for 90 Degree Peel Resistance of Adhesives. Samples were tested on an Instron 5566C5170 Tensometer at a pull rate of 50 mm/minute using the 100N load cell. The results from the 90 Degree Peel Resistance tests are summarized in Table 1, herein.

Table 1 also contains rheology data for the composition of Examples 1 and 2 and Comparative Example 1 under the conditions described therein. An ARES-RDA instrument (TA Instruments) with 2KSTD standard flexular pivot spring transducer, with forced convection oven was used to measure the minimum storage modulus (min G′ in kPa), the temperature at which the min G′ value is reached, loss modulus (G″), the maximum tan delta, the temperature at which the maximum tan delta is observed, and the G′/G″ crossover (gel point) temperature. Test specimens (e.g., 8 mm wide, 1 mm thick) were loaded in between parallel plates and measured using small strain oscillatory rheology while ramping the temperature in a range from 25° C. to 300° C. at 2° C./min (frequency 1 Hz).

TABLE 1

| | Catalyst | | | | | | | | | | | |
|---|---|---|---|---|---|---|---|---|---|---|---|---|
| | and | | | | | T max | | 90° Peel | | | | |
| | amount | | | T min | Max | tan δ | T G′/G″ | strength | Failure | Silanol | | |
| Example | (ppm) | Conditions | Min G′ (kPa) | G′ (° C.) | tan δ | (° C.) | (° C.) | (ppi) | Mode | (mol %) | T_{g}¹ (° C.) | T_{g}²(° C.) |
| 1 | DBU (50) | initial | 105.7 | 128.15 | 1.03 | 124.09 | 130.25 | 4 | adhesive | 18.5 | −6 | 79 |
| 1 | DBU (50) | 40° C. | 334.76 | 118.72 | 0.823 | 111.35 | all <1 | | | 18.5 | −6 | 79 |
| | | 10 days | | | | | | | | | | |
| 1 | DBU (50) | 80° C. | Cured, not | | | | | | | 18.5 | −6 | 79 |
| | | 24 hrs | measurable by | | | | | | | | | |
| | | | method | | | | | | | | | |
| 1 | Al(acac)₃ | initial | 0.51 | 171.66 | 2.4 | 171.66 | 193.65 | 7 | cohesive | 18.5 | −6 | 79 |
| | (75) | | | | | | | | | | | |
| 1 | Al(acac)₃ | 40° C. | 0.51 | 174.22 | 2.1 | 162.95 | 193.64 | 6 | cohesive | 18.5 | −6 | 79 |
| | (75) | 10 days | | | | | | | | | | |
| 1 | Al(acac)₃ | 80° C. | 0.698 | 173.46 | 1.95 | 170.2 | 192.67 | 7 | cohesive | 18.5 | −6 | 79 |
| | (75) | 24 hrs | | | | | | | | | | |
| 2 | 10 ppm | initial | 8.923 | 155.34 | 1.3 | 142.7 | 162.7 | 4 | cohesive | 18.5 | −115 | 89 |
| | DBU | | | | | | | | | | | |
| 2 | 10 ppm | 40° C. | 6.807 | 159.1 | 1.25 | 147.68 | 164.25 | 4 | adhesive | 10.0 | −115 | 89 |
| | DBU | 10 days | | | | | | | | | | |
| 2 | 10 ppm | 80° C. | 42.364 | 162.67 | 0.61 | 139.58 | all <1 | 2 | adhesive | 10.0 | −115 | 89 |
| | DBU | 24 hrs | | | | | | | | | | |
| Comp. 1 | Pt | initial | 0.109 | 74.791 | 30.4 | 76.086 | 85.576 | 7 | cohesive | | | |
| Comp. 1 | Pt | 40° C. | Cured, not | | | | | 0 | adhesive | | | |
| | | 10 days | measurable by | | | | | | | | | |
| | | | method | | | | | | | | | |
| Comp. 1 | Pt | 80° C. | Cured, not | | | | | 0 | adhesive | | | |
| | | 24 hrs | measurable by | | | | | | | | | |
| | | | method | | | | | | | | | |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

The following embodiments are provided, the numbering of which is not to be construed as designating levels of importance:

Embodiment 1 relates to an adhesive composition comprising: an organosiloxane block copolymer, wherein the blocks of the block copolymer consist of an —Si—O—Si— backbone and wherein:

the organosiloxane block copolymer comprises at least two blocks that are phase-separated;
the organosiloxane block copolymer having at least a first glass transition temperature (T_{g}¹) and a second glass transition temperature (T_{g}²), the second glass transition temperature being at 25° C. or higher;
wherein a 1 mm thick cast film of the adhesive composition has a light transmittance of at least 95% and wherein the adhesive composition is B-staged at about T_{g}² or at about 100° C. below T_{g}².

Embodiment 2 relates to the adhesive composition of Embodiment 1, wherein T_{g}² is at about 50° C. or higher; about 80° C. or higher; or about 100° C. or higher.

Embodiment 3 relates to the adhesive composition of Embodiments 1-2, wherein T_{g}² is from about 25° C. to about 300° C.

Embodiment 4 relates to the adhesive composition of Embodiments 1-3, wherein the adhesive composition cures at a temperature above T_{g}².

Embodiment 5 relates to the adhesive composition of Embodiments 1-4, wherein T_{g}¹ is less than about 40° C. and T_{g}² is at or near the operating temperature of an electronic device.

Embodiment 6 relates to the adhesive composition of Embodiments 1-5, wherein T_{g}¹ is from about −130° C. to about 40° C. and T_{g}² is from about 60° C. to about 250° C.

Embodiment 7 relates to the adhesive composition of Embodiments 1-6, wherein the adhesive composition has a maximum tan δ of from about 0.5 to about 2.5 at a temperature of from about 100° C. to about 200° C. after B-staging at about 80° C. for about 24 hours.

Embodiment 8 relates to the adhesive composition of Embodiments 1-7, wherein the adhesive composition has a minimum G′ value of from about 0.5 to about 350 kPa at a temperature from about 100° C. to about 200° C. after B-staging at about 80° C. for about 24 hours.

Embodiment 9 relates to the adhesive composition of Embodiments 1-8, wherein the adhesive composition has a G′/G″ crossover at a temperature of from about 120° C. to about 200° C. after B-staging at about 80° C. for about 24 hours.

Embodiment 10 relates to the adhesive composition of Embodiments 1-9, wherein the adhesive composition has a 90° peel strength in pounds per inch (ppi) of from about 4 ppi to about 8 ppi after B-staging at 80° C. for 24 hours.

Embodiment 11 relates to the adhesive composition of Embodiments 1-10, wherein a 1 mm thick cast sheet of the adhesive composition has a light transmittance of at least 95% before, during or after curing.

Embodiment 12 relates to the adhesive composition of Embodiments 1-11, wherein the organosiloxane block copolymer comprises:

50 to 85 mole percent disiloxy units of the formula [R¹₂SiO_{2/2}],
15 to 50 mole percent trisiloxy units of the formula [R²SiO_{3/2}],
2 to 30 mole percent silanol groups [≡SiOH];
wherein:
each R¹, at each occurrence, is independently a C₁ to C₃₀ hydrocarbyl,
each R², at each occurrence, is independently a C₁ to C₂₀ hydrocarbyl,
wherein:
the disiloxy units [R¹₂SiO_{2/2}] are arranged in linear blocks having an average of from 40 to 250 disiloxy units [R¹₂SiO_{2/2}] per linear block,
the trisiloxy units [R²SiO_{3/2}] are arranged in non-linear blocks having a molecular weight of at least 500 g/mole, and at least 30% of the non-linear blocks are crosslinked with each other, each linear block is linked to at least one non-linear block, and
the organosiloxane block copolymer has a weight average molecular weight (M_{w}) of at least 20,000 g/mole.

Embodiment 13 relates to the adhesive composition of Embodiments 1-12, further comprising a condensation catalyst.

Embodiment 14 relates to the adhesive composition of Embodiment 13, wherein the condensation catalyst comprises at least one of a metal ligand complex and an organic base.

Embodiment 15 relates to the adhesive composition of Embodiment 14, wherein the metal ligand complex comprises a tetravalent tin-containing metal ligand complex or an aluminum-β-diketonate metal ligand complex.

Embodiment 16 relates to the adhesive composition of Embodiment 14, wherein the organic base is an organic base is 1,8-Diazabicyclo[5.4.0]undec-7-ene (DBU).

Embodiment 17 relates to the adhesive composition of Embodiments 1-16, further comprising an adhesion promoter.

Embodiment 18 relates to a film comprising the adhesive composition of Embodiments 1-17.

Embodiment 19 relates to the cured product of the adhesive composition of Embodiments 1-18.

Embodiment 20 a method of bonding an electronic device to a substrate comprising:

applying the adhesive composition of claim 1 to the electronic device, the substrate or both;
contacting the electronic device and the substrate; and
B-staging the adhesive composition at about T_{g}² or at about 100° C. below T_{g}².

Embodiment 21 relates to the method of Embodiment 20, further comprising curing adhesive composition.

What is claimed is:

1. An adhesive composition comprising:
an organosiloxane block copolymer, wherein the blocks of the block copolymer consist of an —Si—O—Si— backbone and wherein:
the organosiloxane block copolymer comprises at least two blocks that are phase-separated;
the organosiloxane block copolymer having at least a first glass transition temperature (T_{g}¹) and a second glass transition temperature (T_{g}²), the second glass transition temperature being at 25° C. or higher;
wherein a 1 mm thick cast film of the adhesive composition has a light transmittance of at least 95% and wherein the adhesive composition is B-staged at about T_{g}² or at about 100° C. below T_{g}².

2. The adhesive composition of claim 1, wherein T_{g}² is at about 50° C. or higher; about 80° C. or higher; or about 100° C. or higher.

3. The adhesive composition of claim 1, wherein T_{g}² is from about 25° C. to about 300° C.

4. The adhesive composition of claim 1, wherein the adhesive composition cures at a temperature above T_{g}².

5. The adhesive composition of claim 1, wherein T_{g}¹ is less than about 40° C. and T_{g}² is at or near the operating temperature of an electronic device.

6. The adhesive composition of claim 1, wherein T_{g}¹ is from about −130° C. to about 40° C. and T_{g}² is from about 60° C. to about 250° C.

7. The adhesive composition of claim 1, wherein the adhesive composition has a maximum tan δ of from about 0.5 to about 2.5 at a temperature of from about 100° C. to about 200° C. after B-staging at about 80° C. for about 24 hours.

8. The adhesive composition of claim 1, wherein the adhesive composition has a minimum G′ value of from about 0.5 to about 350 kPa at a temperature from about 100° C. to about 200° C. after B-staging at about 80° C. for about 24 hours.

9. The adhesive composition of claim 1, wherein the adhesive composition has a G′/G″ crossover at a temperature of from about 120° C. to about 200° C. after B-staging at about 80° C. for about 24 hours.

10. The adhesive composition of claim 1, wherein the adhesive composition has a 90° peel strength in pounds per inch (ppi) of from about 4 ppi to about 8 ppi after B-staging at 80° C. for 24 hours.

11. The adhesive composition of claim 1, wherein a 1 mm thick cast sheet of the adhesive composition has a light transmittance of at least 95% before, during or after curing.

12. The adhesive composition of claim 1, wherein the organosiloxane block copolymer comprises:
50 to 85 mole percent disiloxy units of the formula [R¹₂SiO_{2/2}],
15 to 50 mole percent trisiloxy units of the formula [R²SiO_{3/2}],
2 to 30 mole percent silanol groups [≡SiOH];
wherein:
each R¹, at each occurrence, is independently a C₁ to C₃₀ hydrocarbyl,
each R², at each occurrence, is independently a C₁ to C₂₀ hydrocarbyl,
wherein:
the disiloxy units [R¹₂SiO_{2/2}] are arranged in linear blocks having an average of from 40 to 250 disiloxy units [R¹₂SiO_{2/2}] per linear block,
the trisiloxy units [R²SiO_{3/2}] are arranged in non-linear blocks having a molecular weight of at least 500 g/mole, and at least 30% of the non-linear blocks are crosslinked with each other, each linear block is linked to at least one non-linear block, and
the organosiloxane block copolymer has a weight average molecular weight (M_{w}) of at least 20,000 g/mole.

13. The adhesive composition of claim 1, further comprising a condensation catalyst.

14. The adhesive composition of claim 13, wherein the condensation catalyst comprises at least one of a metal ligand complex and an organic base.

15. The adhesive composition of claim 14, wherein the metal ligand complex comprises a tetravalent tin-containing metal ligand complex or an aluminum-β-diketonate metal ligand complex.

16. The adhesive composition of claim 14, wherein the organic base is an organic base is 1,8-Diazabicyclo[5.4.0]undec-7-ene (DBU).

17. The adhesive composition of claim 1, further comprising an adhesion promoter.

18. A film comprising the adhesive composition of claim 1.

19. A cured product of the adhesive composition of claim 1.

20. A method of bonding an electronic device to a substrate comprising:
applying the adhesive composition of claim 1 to the electronic device, the substrate or both;
contacting the electronic device and the substrate; and
B-staging the adhesive composition at about T_{g}² or at about 100° C. below T_{g}².

21. The method of claim 20, further comprising curing adhesive composition.
